(19) United States
(12) Patent Application Publication
(10) Pub. No.: US 2026/0218783 A1
(43) Pub. Date: Jul. 30, 2026

(54) COMPACT CO-AXIAL REDUCTION DRIVE UNIT

(71) Applicant: Eaton Intelligent Power Limited, Dublin 4 (IE)

(72) Inventors: Carlos Henrique WINK, Granville, MI (US); Ameya Ramakrishna KULKARNI, Pune (IN); Pritam S. BHURKE, Pune (IN); Akhil BASUTKAR, Hyderbad (IN); Sahil CHAWLA, Hamirpur (IN); Soniya V. LAHOTI, Pune (IN); Rushikesh PARANJAPE, Pune (IN); Nikhil S. MAHAJAN, Thane (West) (IN); Chinmaya CHETAN, Bellary (IN); Michal BAK, Gdansk (PL); Grzegorz KONOPKA, Trabki Wielkie (PL); Amarnadh BORRA, Pune (IN)

(21) Appl. No.: 19/148,862

(22) PCT Filed: Jan. 24, 2024
(86) PCT No.: PCT/EP2024/025044

§ 371 Date: Jul. 17, 2025

Related U.S. Application Data
(60) Provisional application No. 63/481,354, filed on Jan. 24, 2023.

(51) Int. Cl. F16H 37/08; B60K 1/00; B60K 17/08; B60K 17/16; F16H 48/08; F16H 48/38; F16H 48/40

(52) U.S. Cl. CPC F16H 37/082; B60K 1/00; B60K 17/08; B60K 17/165; F16H 48/08; F16H 48/40; B60K 2001/001; F16H 2048/385

(57) ABSTRACT

A reduction drive unit can include a differential arrangement including a differential case housing a plurality of pinion gears intermeshed with a pair of side gears; and a compound planetary gear arrangement including a sun gear, a fixed ring gear, a plurality of planet gears. The planet gears are supported by the differential case or a carrier coupled to the differential case. A lubrication system forces lubrication towards the planetary gear arrangement. The lubrication system may utilize a splash lubrication arrangement and/or a forced lubrication arrangement within the differential case.

### CROSS-REFERENCE TO RELATED APPLICATIONS

This application claims priority to U.S. Provisional Application No. 63/481,354, filed on Jan. 24, 2023, the disclosure of which is incorporated herein by reference in its entirety.

### TECHNICAL FIELD

The present disclosure relates to differentials used vehicle drivetrains, and more specifically, to open differentials incorporating planetary gear sets in advantageous arrangements to achieve speed reductions.

### BACKGROUND

Reduction drive units or differential assemblies for use in motor vehicles are used to provide a gear reduction between a drive shaft from a power plant to axle half-shafts coupled to wheels of a vehicle. Differential assemblies also allow for differential speeds between the axle half-shafts. Differentials are well known devices used in vehicle drive trains. These devices operate to couple a pair of rotating members, such as drive shafts or axle half shafts about a rotational axis. Thus, differentials have been employed as a part of transfer cases that operatively couple the front and rear axles of a vehicle, in open differentials as well as limited slip and locking differentials used to couple axle half shafts, and other applications commonly known in the art.

Differentials of the type known in the related art may include a housing and a gear case that is operatively supported by the housing for rotation by a vehicle drive train. The differential typically includes at least a pair of side gears. The side gears are splined for rotation with a pair of rotating members, such as axle half shafts. A spider having cross pins is operatively mounted for rotation with the gear case. Pinion gears are mounted for rotation with the cross pins and in meshing relationship with the side gears. Differential rotation of the side gears and thus the axle half shafts may be obtained through rotation of the pinion gears relative to the cross pins as is commonly known in the art.

### SUMMARY

A differential for a vehicle can include a housing; a differential gear arrangement disposed within the housing, the differential gear including a plurality of pinion bevel gears and a pair of side gears connected to a pair of half-shafts; a hollow drive shaft for connection with an electric motor, the hollow drive shaft extending over and being coaxially aligned with one of the pair of half-shafts; a sun gear formed with or coupled to the hollow drive shaft; a ring gear fixedly secured to the housing; and a planetary gear arrangement including three planet gear members, each of the three planet members including a first stage planet gear intermeshed with the sun gear and a second stage planet gear intermeshed with the ring gear.

A reduction drive unit can include a differential arrangement including a differential case housing a plurality of pinion gears intermeshed with a pair of side gears; and a compound planetary gear arrangement including a sun gear, a fixed ring gear, a plurality of planet gears, and a carrier structure rotationally supporting the plurality of planet gears, wherein: the carrier structure is rigidly mounted to the differential case; each of the plurality of planet gears has a first stage gear intermeshed with the sun gear and an axially offset second stage gear intermeshed with the fixed ring gear; and the ring gear is axially offset from the sun gear such that the sun gear is located axially between the ring gear and the differential arrangement.

A reduction drive unit can include a housing assembly including a first housing part mated to a second housing part; a differential arrangement including a differential case housing a plurality of pinion gears intermeshed with a pair of side gears, the differential arrangement being housed entirely within the first housing part; and a compound planetary gear arrangement including a sun gear, a fixed ring gear, a plurality of planet gears, and a carrier structure rotationally supporting the plurality of planet gears, wherein: the carrier structure is rigidly mounted to the differential case; each of the plurality of planet gears has a first stage gear intermeshed with the sun gear and a second stage gear intermeshed with the fixed ring gear; and the sun gear, the fixed ring gear, and the plurality of planet gears are housed entirely within the second housing part.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a schematic cross-sectional view of a compact co-axial reduction unit having features in accordance with the present disclosure.

FIG. 2 is a schematic cross-sectional view of the compact co-axial reduction unit shown in FIG. 1 illustrating a power flow.

FIG. 3 is a schematic cross-sectional end view of the compact co-axial reduction unit shown in FIG. 1.

FIG. 4 is a schematic perspective exploded view of the compact co-axial reduction unit shown in FIG. 1.

FIG. 5 is a cross-sectional view of a drive system including an electric motor and differential reduction drive unit having features in accordance with principles of the present disclosure, according to an example.

FIG. 6 is a perspective view of the differential reduction drive unit shown in FIG. 5 with components exploded away from each other for ease in viewing.

FIG. 7 is a lateral cross-sectional view of a portion of the differential reduction drive unit shown in FIG. 5.

FIG. 8 is a longitudinal cross-section of the differential reduction drive unit shown in FIG. 5 and further showing a power flow through the unit.

FIG. 9 is a perspective view of an example sub-assembly of the differential reduction drive unit shown in FIG. 5.

FIG. 10 is a cross-sectional view of an example differential having a first type of lubrication system configured in accordance with the principles of the present disclosure.

FIG. 11 is another cross-sectional view of the differential of FIG. 10 in which lubrication pathways to the planetary gear arrangement are visible.

FIG. 12 is another cross-sectional view of the differential of FIG. 10 in which lubrication pathways to the differential gear set are visible.

FIG. 13 is a cross-sectional view of an example differential having a second type of lubrication system configured in accordance with the principles of the present disclosure.

FIG. 14 is another cross-sectional view of the differential of FIG. 13 in which lubrication pathways to the differential gear set are visible.

FIG. 15 is another cross-sectional view of the differential of FIG. 13 in which lubrication pathways through the differential case are visible.

FIG. 16 is another cross-sectional view of the differential of FIG. 13 in which lubrication pathways through the carrier to the planetary gear set are visible.

FIG. 17 is a perspective view of an example differential case suitable for use in any of FIGS. 10-17.

FIG. 18 is a cross-sectional view of an example differential having a third type of lubrication system configured in accordance with the principles of the present disclosure.

FIG. 19 is a transverse cross-section taken along the 19-19 line of FIG. 18.

FIG. 20 is a cross-sectional view of the differential of FIG. 18 in which lubrication pathways to the planetary gear arrangement are visible.

FIG. 21 is a cross-sectional view of an example differential having a fourth type of lubrication system configured in accordance with the principles of the present disclosure.

FIG. 22 shows a lubrication pathway through the housing of the differential of FIG. 21.

FIG. 23 is a perspective view of an example differential case suitable for use with the differential of FIG. 21.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. The following detailed description is therefore not to be taken in a limiting sense, and the scope of the present disclosure is defined by the appended claims and their equivalents.

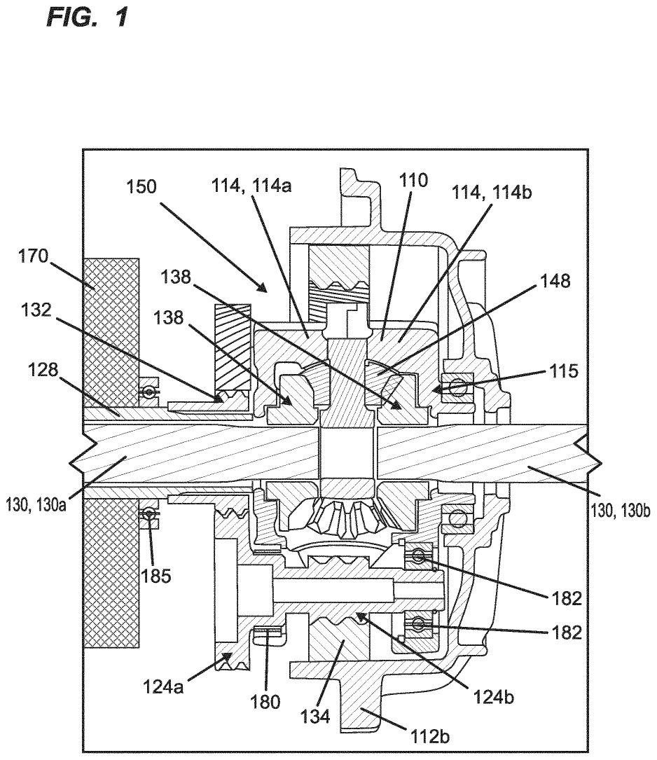

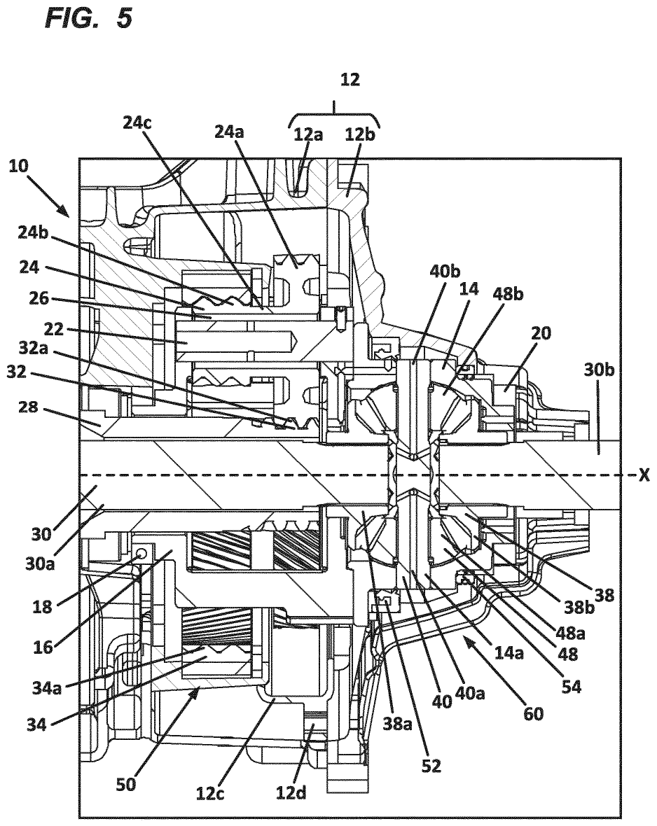

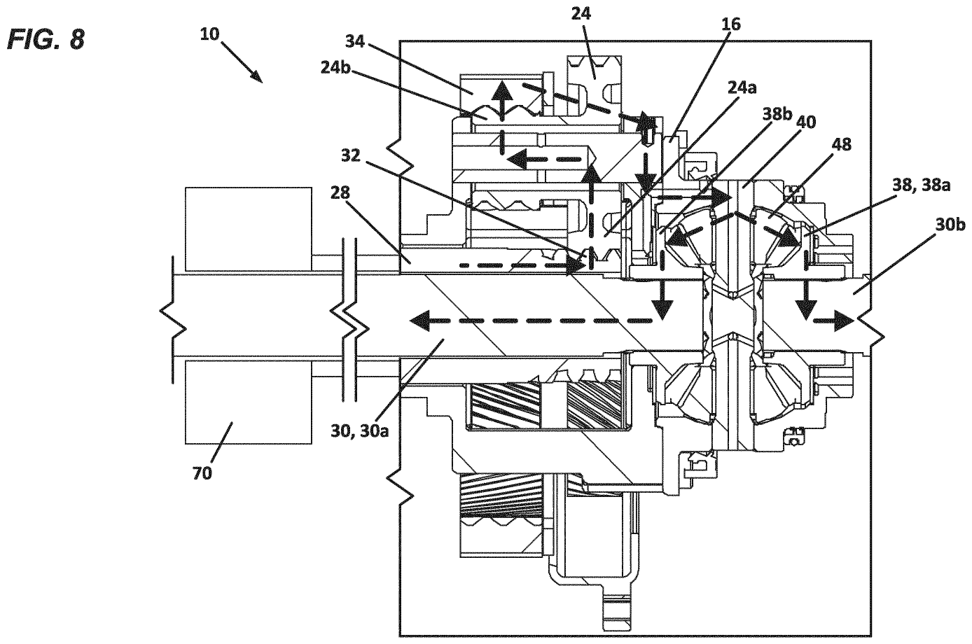

The figures in general shows example drive systems suitable for use in, for example, a vehicle application. As shown, the drive systems include an electric motor assembly 70, 170 (e.g., see FIGS. 1 and 8) and a differential assembly 10, 110. One representative example of a differential assembly 10, 110 of the type that may employ a side gear and a pinion gear of the type contemplated by the present teachings is generally shown at 10, 110 in FIGS. 1 and 5, where like numerals are used to designate like structure throughout the drawings. The differential 10, 110 is designed to be employed as a part of a drive train for any number of vehicles having a power plant that is used to provide motive force to the vehicle.

Thus, those skilled in the art will appreciate, in light of the disclosure, that the differential 10, 110 may be employed as a part of a transfer case that operatively couples the front and rear axles of a vehicle, in an open differential, a limited slip differential, or locking differential used to couple axle half shafts, as well as other applications commonly known in the art. The limited slip or locking differentials may be hydraulically actuated or electronically actuated and therefore include coupling mechanisms, such as friction clutches employed to operatively couple the axle half shafts together under certain operating conditions. It will be appreciated in light of the disclosure that the purpose of the differential 10, 110 is merely to provide one basic representative example of a device that may employ the features of the present teachings, and is not meant to limit the application of the present teachings to the type of differential represented therein.

With this in mind, in its most elementary configuration, the differential 10, 110 may include a housing assembly, generally indicated at 12, 112. In one aspect, the housing assembly 12, 112 can include a motor housing 12a that is mated to a differential housing 12b, 112b with fasteners (not shown), such as screws or bolts. The motor housing 12a is configured to at least partially enclose a motor 70, 170 (e.g., an electric motor, a hybrid electric motor, etc.). The differential housing 12b, 112b at least partially encloses a differential case 14, 114 including a differential gear arrangement 15, 115. The differential gear arrangement 15, 115 connects two axle shafts 30, 130 (e.g., axle half shafts) of the vehicle. A drive shaft 28, 128 extends over a first 30a, 130a of the axle shafts 30, 130 and is driven by the motor 70, 170. A compound planetary gear arrangement 50, 150 operably connects the drive shaft 28, 128 to the differential housing 12, 112, which is operably connected to the differential gear set 15, 115. Accordingly, the compound planetary gear set 50, 150 and the differential gear set 15, 115 connect the motor 70, 170 to the second 30b, 130b of the axle shafts 30, 130.

The compound planetary gear arrangement 50, 150 includes a sun gear 32, 132, a ring gear 34, 134, and two or more planet gears 24, 124. The sun gear 32, 132 operably connects to the drive shaft 28, 128 and is driven by the motor 70, 170. The ring gear 34, 134 is rotationally fixed to the housing assembly 12, 112 so that the ring gear 34, 134 rotates with the housing assembly 12, 112. Each of the planet gears 24, 124 includes a first gear portion 24a, 124a that interfaces with the sun gear 32, 132 and a second gear portion 24b, 124b that interfaces with the ring gear 34, 134. Rotational torque from the drive shaft 28, 128 is passed to the sun gear 32, 132, along the planetary gears 24, 124, to the ring gear 34, 134, and thereby to the housing assembly 12, 112. Rotational torque of the housing assembly 12, 112 is transferred through the differential gear set 15, 115 to the second axle 30b, 130b as is commonly known in the art.

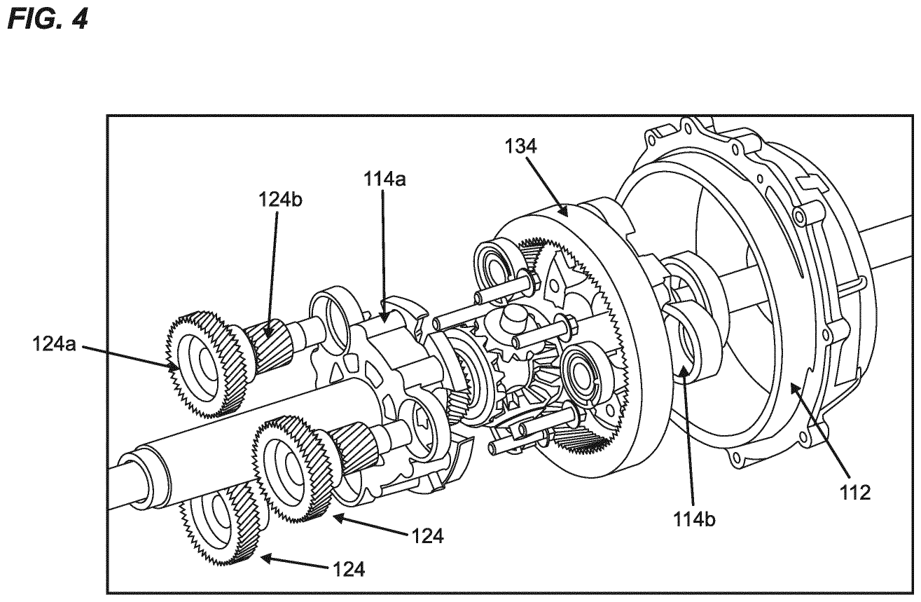

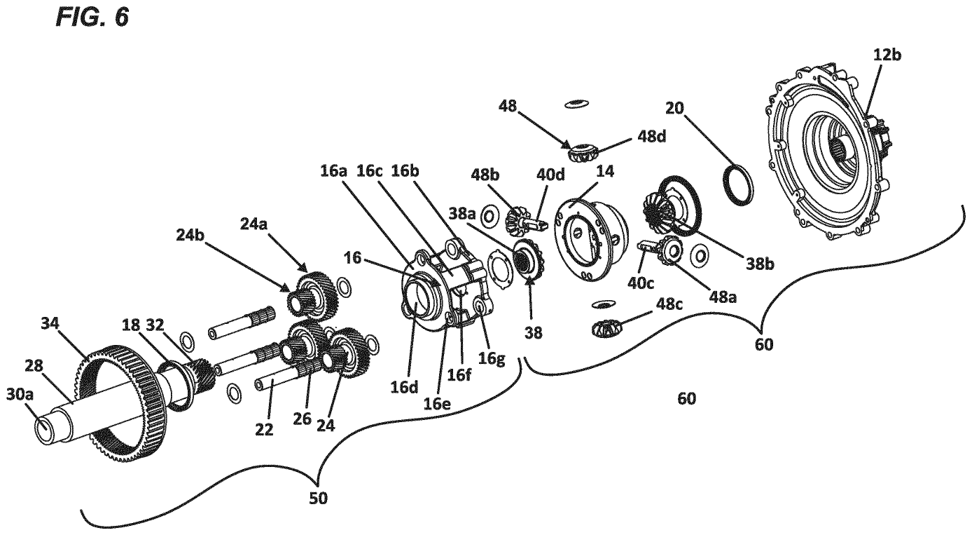

In some implementations, the planet gears 124 are supported by the differential case 114 (e.g., see FIGS. 1-4). For example, in certain implementations, at least the second gear potions 124b of the planet gears 124 are radially aligned with the differential case 114. In other implementations, the planet gears 24 are supported by a carrier 16 (e.g., see FIGS. 5-9). In certain implementations, the carrier 16 is mounted to the differential case 14 (e.g., by fasteners). In certain examples, the carrier 16 is axially offset from the differential case 14 along the drive shaft 28 so that the planet gears 24 are axially offset from the differential case 14.

In some implementations, the compound planetary gear set 150 is arranged coaxially with the differential gear set 115 (e.g., see FIGS. 1-4). The ring gear 134 is disposed about the differential case 114 so that the ring gear 134 radially aligns with the differential gear arrangement 115. Positioning the ring gear 134 about the differential case 114 results in an axially compact footprint for the housing assembly 12. At least the second gear portions 124b of the planet gears 124 also radially align with the differential gear set 115. The sun gear 132 is axially offset relative to the differential gear arrangement 115 so that the sun gear 132 is not radially aligned with the differential gear arrangement 115. The first gear portions 124a of the planet gears 124 radially align with the sun gear 132.

In other implementations, the compound planetary gear set 50 is axially offset from the differential gear set 15 along the rotation axis X of the drive shaft 28 (e.g., see FIGS. 5-9). The ring gear 34 is axially offset from the differential case 14. In certain implementations, the ring gear 34 is disposed radially about the carrier 16 holding the planet gears 24. Axially offsetting the planetary gear set 50 from the differential case 14 along the rotation axis X of the drive shaft 28 results in a radially compact footprint for the housing assembly 12 because the planet gears 24 can overlap the differential case 14 along the rotation axis X of the drive shaft 28.

Referring now to FIGS. 1-4, one example differential 110 includes a compact co-axial reduction unit is shown as including an assembly cover 112b housing a differential case 114 having a right-hand split 114b and a left-hand split 114a. In one aspect, the differential case 114 supports a pair of differential side gears 138 intermeshed with a three differential pinion bevel gears 148. As shown, axle half-shafts 130 are splined or otherwise connected to the differential side gears. The differential case 114 also supports a sun gear 132 rotatably arranged about one 130a of the axle shafts 130.

In certain implementations, at least a portion of the differential case 114 is shown as further supporting a planetary gear arrangement 150 including three planet gear members 124. Each planet gear member 124 includes a first stage planet gear 124a and a second stage planet gear 124b. Such a configuration may be referred to as a compound planet gear member. In one aspect, the differential case 114 acts as a carrier 116 for the planetary gear arrangement 150. A ring gear 134, fixed within the assembly cover 112b, is also provided. In one aspect, each of the planet gear members 124 is supported at one end by ball bearing assemblies 182 and at the opposite end by a needle roller bearing assembly 180.

In one aspect, the sun gear 132 is driven by a rotor of an electric motor 70. In one aspect, the sun gear 132 meshes with the first stage planet gear 124a of the three planet gear members 124. In one aspect, the planet gear members 124 are mounted 120 degrees apart on the carrier 116. In one aspect, each of the planet gear members 124 has two sets of teeth cut on a single shaft to form the first and second stage planet gears 124a, 124b. In one aspect, the planet shaft is supported in the carrier 116 with a needle roller bearing 180 on one side and a ball bearing 182 on the other. In one aspect, the sun gear 132 meshes with first stage planet gears 124a while the second stage planet gear 124b meshes with a ring gear 134. In one aspect, the ring gear 134 is fixed in the housing 112 (e.g., the assembly cover 112b) through protrusions on the ring gear 134 and corresponding semi-circular slots in the housing 112.

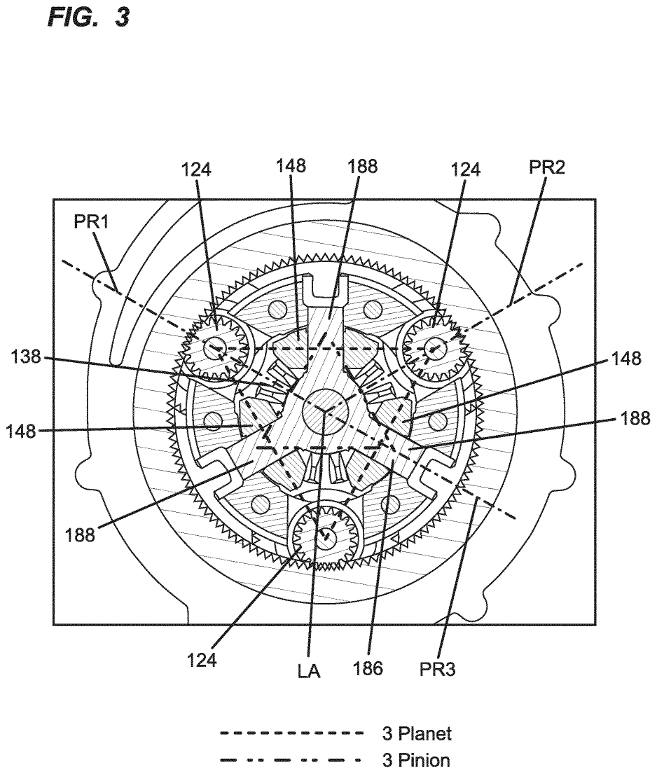

In one aspect, the carrier 116 of the planetary assembly 150 acts as the differential case 114. In certain implementations, the differential case 114 includes a three-pinion yoke assembly 186. In one aspect, the three pinion shafts 188 are mounted at 180 degrees from each planet gear 124 such that forces are appropriately balanced (e.g., see FIG. 3). The pinion gears 148 are mounted on the pinion shafts 188. Accordingly, in the three-pinion design, each pinion gear 148 is disposed opposite a planetary gear 124.

In one aspect, the differential case 114 is a split design. In certain examples, the differential case 114 includes a first body 114a that mates to a second body 114b to enclose the side gears 138 and pinion gears 148. In certain implementations, the first body 114a holds the needle roller bearing arrangement 180 and the second body 114b holds the ball bearing arrangement 182.

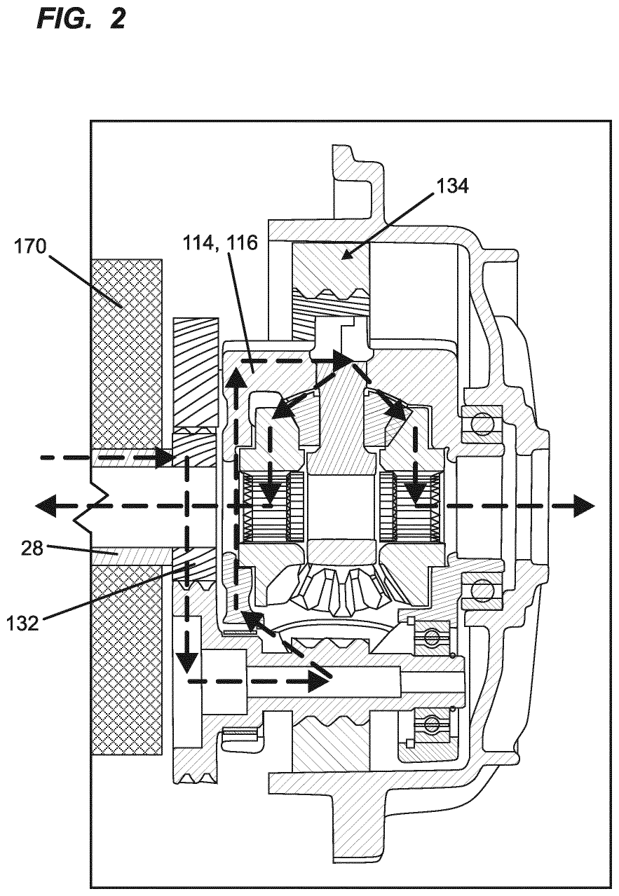

It is noted that the sun gear 132 shown in FIG. 1 differs from that shown in FIG. 2 in that the sun gear 132 is splined to a hollow drive shaft 128 in FIG. 1 and is integrally formed with a hollow drive shaft 128 in FIG. 2. In both cases, the electric motor 170 has a hollow rotor that is the hollow shaft 128 itself or is connected to the hollow shaft 128. As shown at FIG. 1, the hollow drive shaft 128 can be supported by ball bearings 185.

Referring to FIG. 2, which schematically shows a power flow of the differential unit 110, the electric motor 70 drives the sun gear 132, which meshes with the first stage planet gears 124a. Accordingly, the motor torque is amplified by the ratio between the sun gear 132 and the first stage planet gears 124a. This same torque acts on the second stage planet gears 124b and is further amplified by the ratio between the second stage planet gears 124b and the ring gear 134, which is a fixed component. In one aspect, the output of the planet gears 124 is taken from the carrier 116, which may be the differential case 114. From the case 114, power is transferred to the tripod yoke 186 which in turn transmits the power to the side bevel gears 138 via the bevel pinion gears 148. This power is then transferred to the axle shafts 130.

One particularly advantageous combination, and in contrast to a more traditional two-pinion bevel gear differential or a planetary differential, is using a planetary gear arrangement 150 having three compound planet gear members 124 in combination with three bevel gears 148. As can be most easily seen at FIG. 3, such an arrangement allows for the axes PR1, PR2, PR3 of the three pinion shafts 188 associated with the tripod yoke 186, which is the same as the rotational axes for the pinon bevel gears 148, to be radially aligned with the compound planet member 124 on the opposite side of the longitudinal axis L of the differential 110 such that forces can be optimally balanced.

The disclosed design has multiple advantages. For example, the design provides for a compact design for a high reduction ratio. For example, a fewer number of bearings for a differential assembly is needed. For example, the planet and differential pinion shafts 188 are mounted in a structural component 186 which acts as a casing 114 as well as planet carrier 116. For example, the planet gear 124 is directly mounted in a carrier 116 using external bearings 180, 182 such that planet pins are avoided. In certain examples, the reliability of the system is high due to lesser number of components used. In certain examples, the design has the advantage of ease of assembly. In certain examples, the design has the advantage of the high quality of compound planet gear manufacturing due to its unique design.

Referring now to FIGS. 5-9, another example differential 10 includes a separate planetary gear carrier 16 and differential case 14. In certain implementations, the carrier 16 is offset from the differential case 14 along the longitudinal axis X of the differential 10. In certain implementations, the carrier 16 is mechanically fastened or otherwise coupled to the differential case 14 to move in unison with the differential case 14. In certain implementations, at least a majority of the differential case 14 is mounted within the differential housing 12b of the housing 12 while at least a majority of the carrier 16 is mounted within the motor housing 12a of the housing 12. In certain examples, the differential housing 12b includes an assembly cover.

In one aspect, a lower baffle structure 12c is provided and secured to the motor housing 12a, for example by fasteners 12d. The baffle structure 12c partially surrounds planet gears 24 which are discussed in greater detail later. A differential case, generally indicated at 14, may be operatively supported in the housing assembly 12 for rotation in driven relationship by the drive train, as is commonly known in the art. Those skilled in the art will appreciate in light of the disclosure that the differential case 14 and housing assembly 12 may be defined by any conventional structure known in the related art and that the present teachings are not limited to the particular housing assembly 12 illustrated here nor to the illustrated differential case 14.

In certain implementations, the differential gear arrangement 15 includes a side gear 38 for each axle shaft 30, one or more pinion gears 48 connecting the side gears 38. In one aspect, the differential case 14 houses a pair of side gears 38a, 38b, collectively referred to as side gears 38, connected to a pair of axle half-shafts 30a, 30b, collectively referred to as axle half-shafts 30. Although not shown in the drawings, the axle half-shafts 30 extend to and drive wheels of a vehicle. The side gears 38 are intermeshed with four pinion gears 48a, 48b, 48c, 48d, collectively referred to as pinion gears 48. As shown, the pinion gears 48 are rotatably supported by pinion shafts 40a, 40b, 40c, 40d, collectively referred to as pinion shafts 40. The pinion shafts 40 extend through openings 14a in the differential case 14 such that rotation of the differential case 14 about a longitudinal axis X causes the pinion shafts 40 and pinion gears 48 to rotate with the differential case 14, which in turn causes the side gears 38 and axle-half shafts 30 to rotate to drive the wheels of the vehicle. The differential case 14, pinion gears 48, pinion shafts 40, and side gears 38 can be collectively referred to as a differential assembly 60. Referring to FIG. 5, it can be seen that seals 52, 54 are provided between the differential case 14 and the housing 12b.

In one aspect, the differential case 14 is connected to and driven by a carrier structure 16 with fasteners, such as screws or bolts. As such, the differential case 14 and carrier structure 16 form a unified rigid structure. The assembled differential case 14 and carrier structure 16 are rotationally supported at one end by a bearing assembly 18 that supports the carrier structure 16 within the motor housing 12a and at the other end by a bearing assembly 20 that supports the differential case 14 within the differential housing 12b. The carrier structure 16 forms part of a planetary gear arrangement 50 including a plurality of planet gears 24 that are rotationally supported by bearing assemblies 26 mounted to fixed pins 22. In the example shown, three bearing assemblies 26 are provided for each planet gear 24 and are configured as needle bearing assemblies. In the example shown, the pins 26 are fixed axially and rotationally using a grub screw with tapping inside the carrier structure 16. In one aspect, the carrier structure 16 includes a first radial wall 16a and a spaced apart second radial wall 16b, between which a plurality of axial legs 16c extend. As shown, the first radial wall 16a defines a central aperture 16d and a plurality of apertures 16e for receiving an end of the pins 22, while the second radial wall 16b defines a central aperture 16f and a plurality of apertures 16g for receiving the opposite end of the pins 22.

As shown, each of the planet gears 24 include a first gear portion 24a and a second gear portion 24b, each defining a plurality of outwardly facing gear teeth. In one aspect, the first gear portion 24a is located more proximate the differential case 14 relative to the second gear portion 24b. In one aspect, the first gear portion 24a has a larger diameter and more gear teeth than the second gear portion 24b. In the example shown, the first gear portion 24a is spaced axially from the second gear portion 24b by an extension portion 24c that is provided without gear or teeth portions. Accordingly, an axial gap exists between the first and second gear portions 24a, 24b. In one aspect, the first gear portion 24a may be referred to as a first stage 24a of the planet gear 24 while the second gear portion 24b may be referred to as a second stage 24b of the planet gear 24. As the planet gears 24 have two different gear sets, the planetary gear arrangement 50 may be referred to as a compound planetary gear arrangement 50.

As most easily seen at FIG. 5, the first gear portion 24a is intermeshed with outwardly facing teeth 32a of a sun gear 32 forming a part of the planetary gear arrangement 50. In the example shown, the sun gear 32 is an integral portion of a hollow drive shaft 28. However, other arrangements are possible, such as attaching a separately formed sun gear 32 to the hollow drive shaft 28. As shown, the hollow drive shaft 28 extends over the axle half-shaft 30a and can be part of or connected to, for example, an electric motor 70 (schematically illustrated at FIG. 8). With continued reference to FIG. 5, the second gear portion 24b is intermeshed with inwardly facing teeth 34a of a ring gear 34. In one aspect, the ring gear 34 is mounted within the motor housing 12a such that the ring gear 24 is held in a fixed position relative to the motor housing 12a and thus the housing assembly 12. In some examples, the ring gear 34 is rotationally fixed in place by the interaction of outwardly facing splines provided on the ring gear 34 and inwardly facing splines provided on the housing 12a. In some examples, the ring gear 34 is rotationally fixed in place with pins extending between the ring gear 34 and housing 12a, for example between crescent moon shaped slots in the housing 12a and ring gear 34.

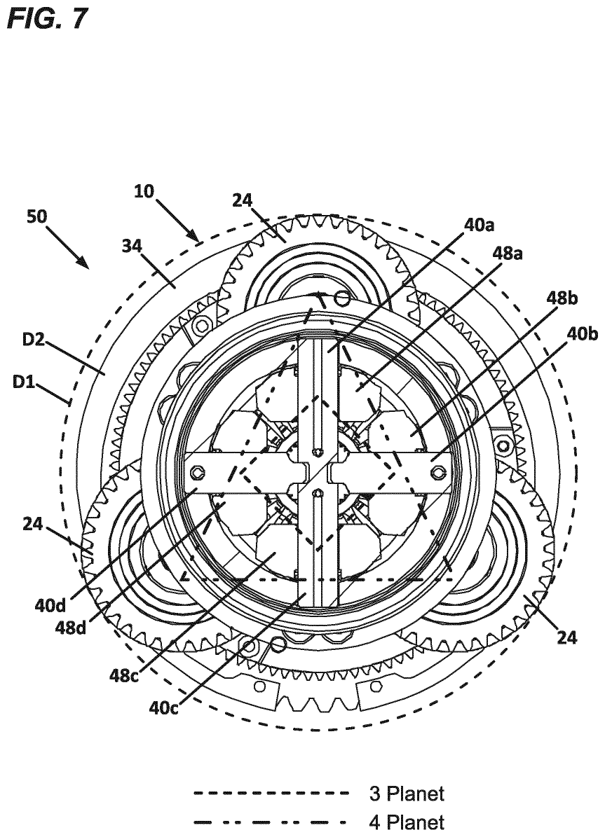

With the disclosed arrangement, it is noted that the sun gear 32 and ring gear 34 are axially offset from each other by the axial distance between the gear portions 24a and 24b. With such an arrangement, the sun gear 32 can be characterized as being located axially between the ring gear 34 and the side gear 38a. On the same basis, the ring gear 34 can be characterized as being axially spaced or offset from the sun gear 32 in a direction away from the side gear 38a and in a direction towards the electric motor 70. With reference to FIG. 7, it can also be seen that the gear portions 24b of the planet gears 24, which are arranged 120 degrees apart from each other, define an outer envelope D1 that is larger than the outside diameter D2 of the ring gear 34. FIG. 7 also illustrates that the three planet gears 24 and the four pinion gears 48 are offset from each other by an equal angle. It is also noted that the legs 16c of the carrier structure 16 are arranged 120 degrees from each other and are offset from the planet gears 24 such that the legs 16c extend at a mid-distance or angle from the planet gears 24. Referring back to FIG. 5, it can be seen that the sun gear 32, planet gears 24, and ring gear 34 of the planetary gear arrangement 50 are disposed entirely within the internal volume defined by the housing 12a and are thus all on the same side of a plane passing through the interface between the housings 12a, 12b. It can also be seen at FIG. 5 that the differential case 14, along with pinion gears 48 and side gears 38 are entirely housed within the internal volume of the housing 12b. As such, the gears 24, 32, 34 of the planetary gear arrangement 50 and the differential gear arrangement can be characterized as being provided within different housings or compartments.

In operation, and with reference to the power flow diagram shown at FIG. 8, the electric motor 70 drives the shaft 28 and sun gear 32. The sun gear 32 in turn meshes and drives the first stage 24a of the planet gear 24 and amplifies torque by the ratio between the sun gear and the first stage 24a of the planet gear 24. This same torque acts on the second stage 24b of the planet gear 24 and the ring gear 34. As the ring gear 34 is rotationally fixed in place, this interaction transmits torque to the carrier structure 16 which in turn drives the pinion shafts 40 and pinion gears 48 to transmit power to the side gears 38 and axle half-shafts 30. In the particular example shown, a gear ratio or reduction of 8:1 between the motor shaft 28 and the axle half-shafts 30 is achieved. Other reductions and gear ratios are possible without departing from the concepts herein.

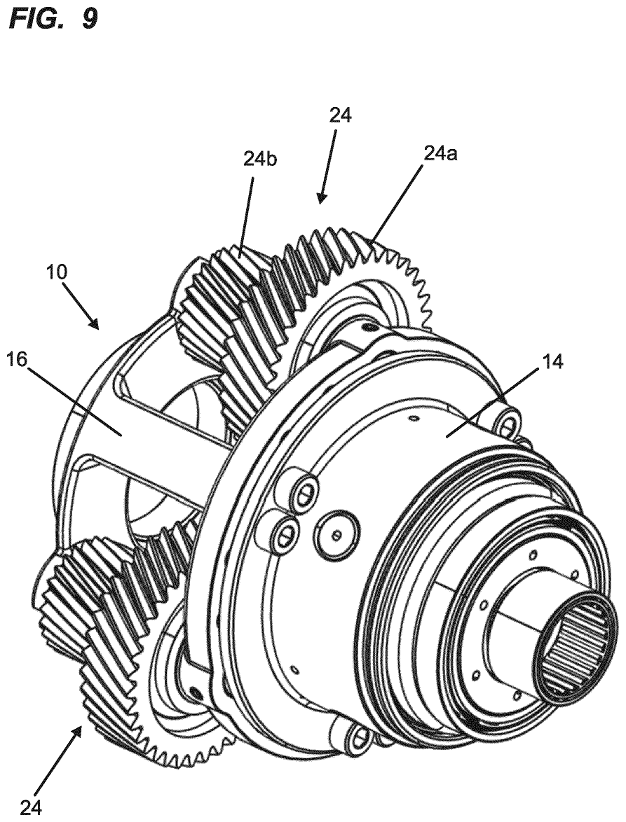

The disclosed design provides for a number of advantages. For example, a compact design with a high gear reduction ratio is provided. For example, assembly is made easier even though the ring gear diameter is smaller than the outer envelope of the first stage gear portions 24a of the planet gears 24. In one advantageous method, the shaft 28 and ring gear 34 are first mounted within the housing 12a and the planetary and differential assemblies 50, 60 are provided as a completed sub-assembly, as shown at FIG. 9, that is then installed onto the shaft 28 and ring gear 34 within the housing 12a, after which the housing 12b can be installed. The disclosed design also advantageously results in the planet carrier acting as the left casing of the differential assembly 10. Further, as the planetary and differential assemblies 50, 60 are provided in different compartments, lubrication is made easier. The disclosed design also reduces the total number of components and therefore increases system reliability. Also, by providing a simple bearing support architecture for the carrier 16/case 14 structure, less deflection results. Further, integrating the sun gear 32 into the shaft 28 minimizes or avoids noise, vibration, harshness (NVH) related issues.

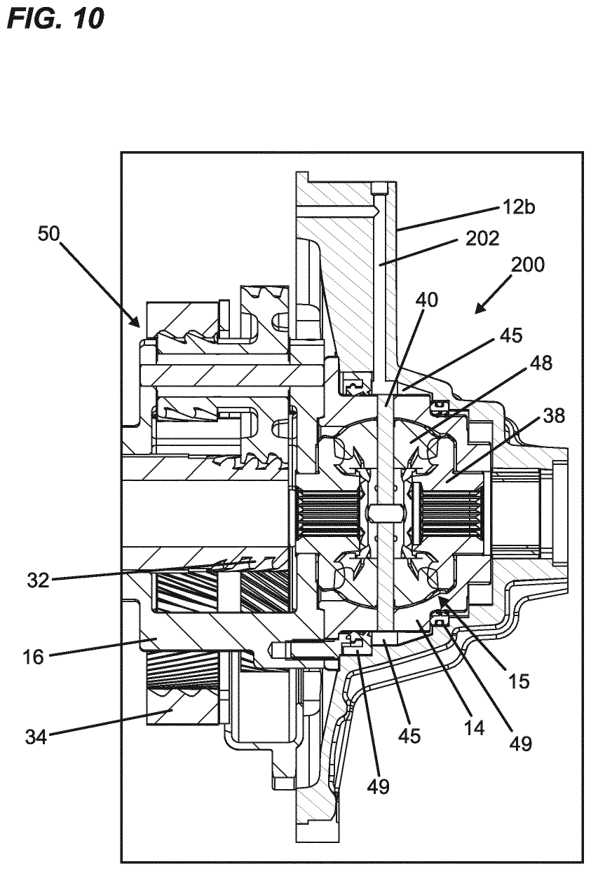

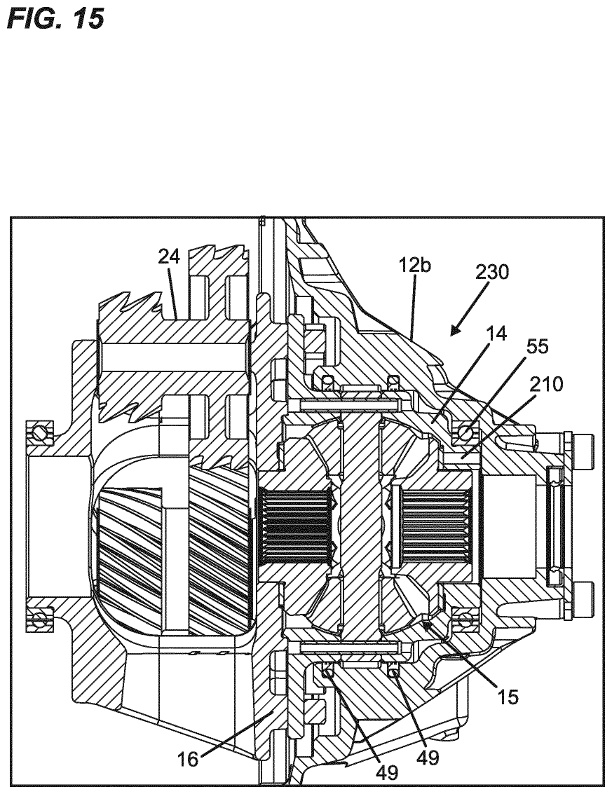

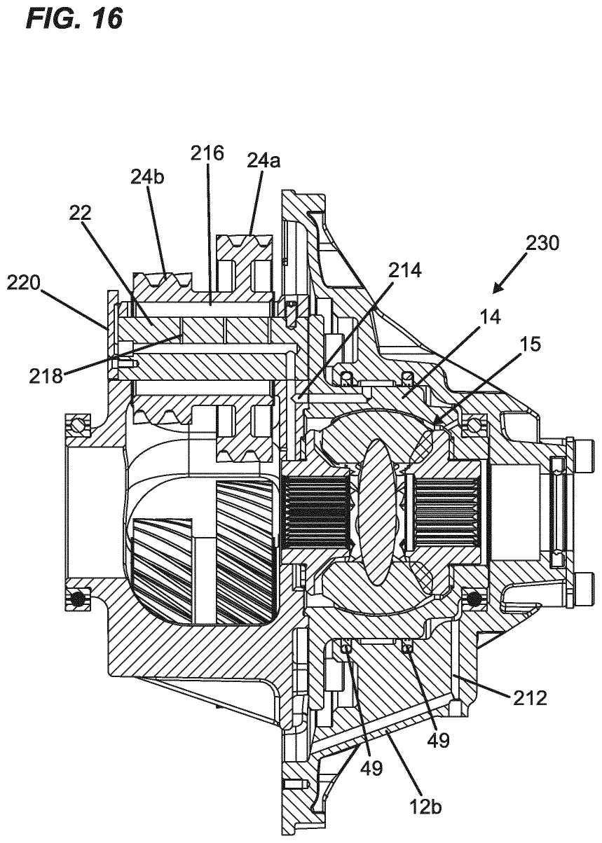

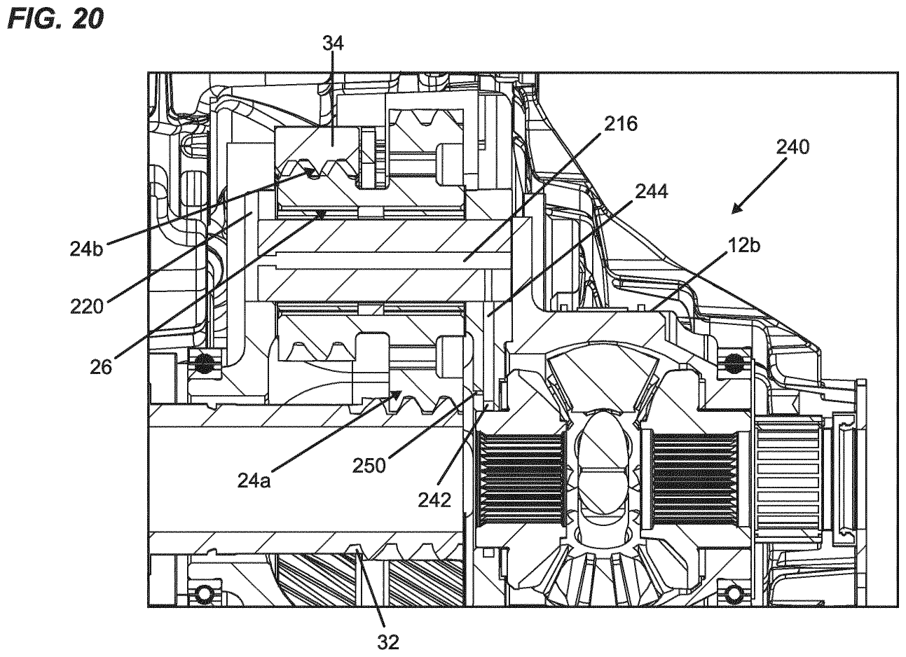

Referring now to FIGS. 10-23, various types of lubrication systems 200, 230, 240, 260 can be utilized with the differential assemblies 10, 110. Example suitable lubricants include oil. For convenience, the various lubrication systems shown herein are illustrated with respect to the differential assembly 10 shown in FIGS. 5-9 where the planetary gear arrangement 50 is held by a carrier 16 offset from the differential case 14. It will be understood, however, that these lubrication systems could also be applied to the differential assembly 110 of FIGS. 1-4.

In some implementations, the differential gear arrangement 15 and the planetary gear arrangement 50 share a lubrication system. In other implementations, however, the differential gear arrangement 15 and the planetary gear arrangement 50 have different lubrication systems. In some implementations, the lubrication system includes a forced circulation path along which lubrication (e.g., pressurized lubrication) is circulated to targeted regions. In certain examples, the lubrication is continuously circulated along the forced circulation path while the vehicle is in operation. In some implementations, the forced circulation system is used only with the planetary gear arrangement 50. In other implementations, the forced circulation system also is used with the differential gear arrangement 15. In other implementations, the lubrication system includes a splash lubrication system in which lubrication is directed to a chamber in which the lubrication system splashes over components disposed within the differential chamber. In certain implementations, the lubrication system includes a hybrid between a forced circulation system and a splash lubrication system.

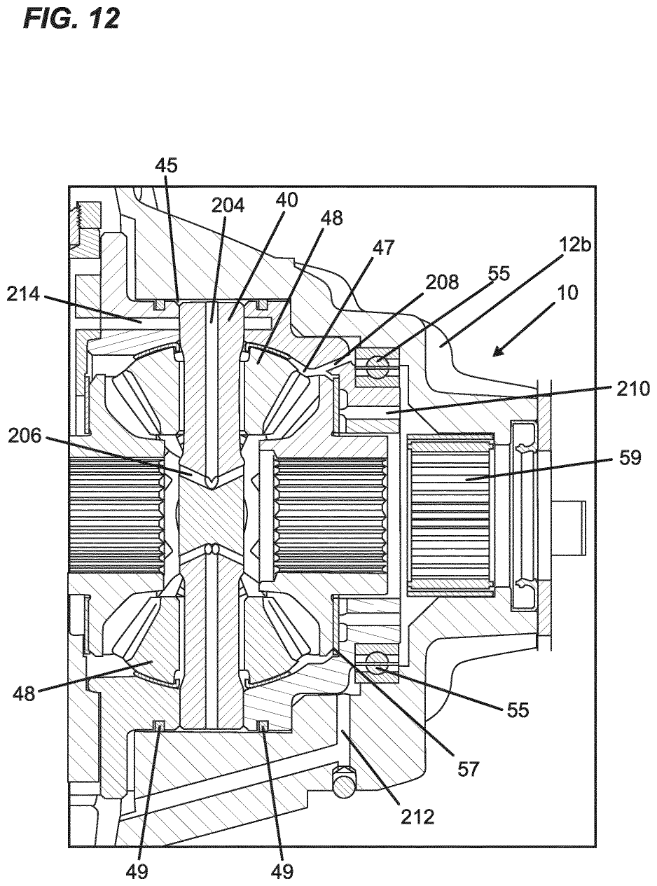

Referring to FIGS. 10-23 in general, each lubrication system 200, 230, 240, 260 includes an inlet pathway 202 defined in the assembly cover 12b leading from the motor housing 12a towards the differential case 14. The inlet pathway 202 directs lubrication (e.g., pressurized lubrication) to an interior chamber 45 of the assembly cover 12b in which the differential case 14 is disposed. The lubrication will splash within the chamber 45, thereby providing lubrication between the differential case 14 and the assembly cover 12b. In some implementations, the assembly cover 12b defines an outlet pathway 212 leading from the interior cavity 45 of the assembly cover 12b back towards the motor housing 12a (e.g., see FIGS. 12, 16, and 21).

The example lubrication systems 200, 230, 240, 260 includes a forced circulation system for use with at least the planetary gear set 50. The forced circulation system includes a series of pathways (e.g., bores or other conduits) extending through the housing assembly 12 and the carrier 16. In some implementations, the first, second, third, and fourth lubrication systems 200, 230, 240, 260 include a first forced circulation system 202 for the planetary gear set 50. In certain implementations, the first forced circulation system 202 includes a bridging pathway 214 from the cavity 45, through the differential case 14, through the carrier 16, and towards the planetary gear set 50. In certain implementations, the bridging pathway 214 leads to at least the interface between the first gear portions 24a of each of the planet gears 24 and the sun gear 32.

In certain implementations, each planetary gear 24 is mounted to the carrier 16 via a pin 22 rigidly fixed to the carrier 16 and bearing assembly 26. In certain such implementations, each pin 22 may define a pin pathway 216 leading from the bridging pathway 214 towards the second gear portion 24b of the respective planet gear 24. In certain implementations, one or more transverse paths 218 lead from the pin pathway 216 outwardly towards the bearing assembly 26 of the planet gear 24. In certain implementations, the pin pathway 216 leads through the pin 22 towards a distribution member 220 disposed at an opposite end of the pin 22 from the differential case 14. In some examples, the distribution member 220 is a deflector 220 that deflects lubrication sprayed from the pin pathway 216 back towards the interface between the second gear portion 24b of the respective planet gear 24 and the ring gear 34. In other examples, the distribution member 220 is a guided closed conduit that directs the fluid towards the interface of the second gear portion 24b and the ring gear 34. In certain implementations, the bridging pathway 214 leads to the interface between the sun gear 32 and the first gear portion 24a of each planet gear 24.

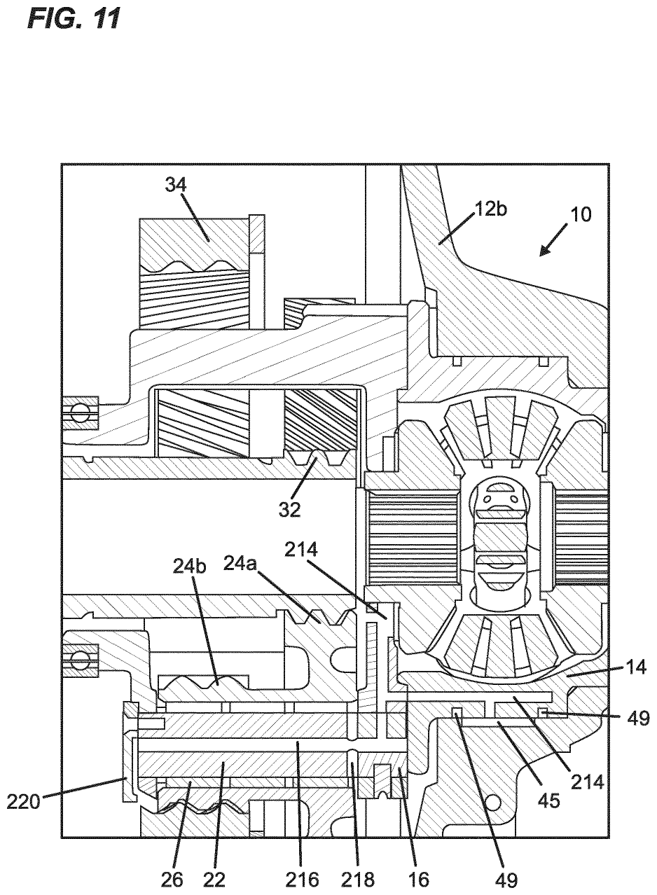

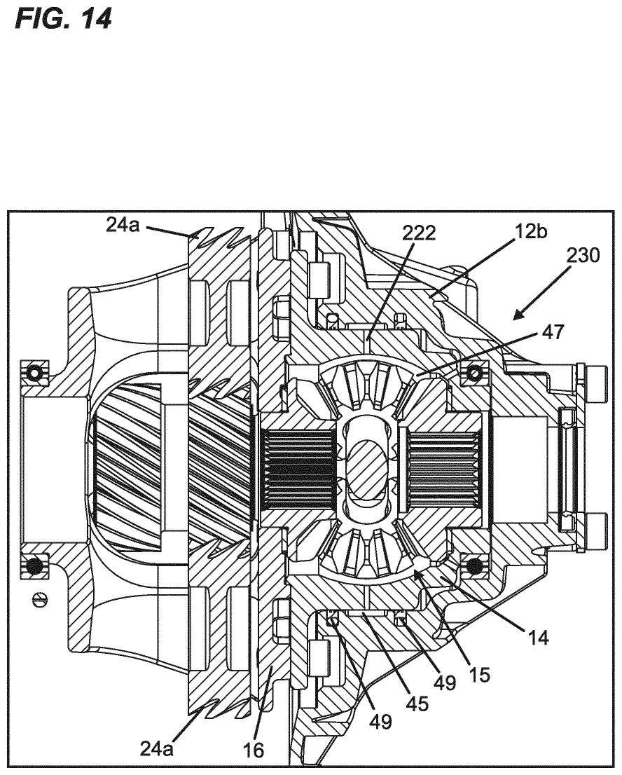

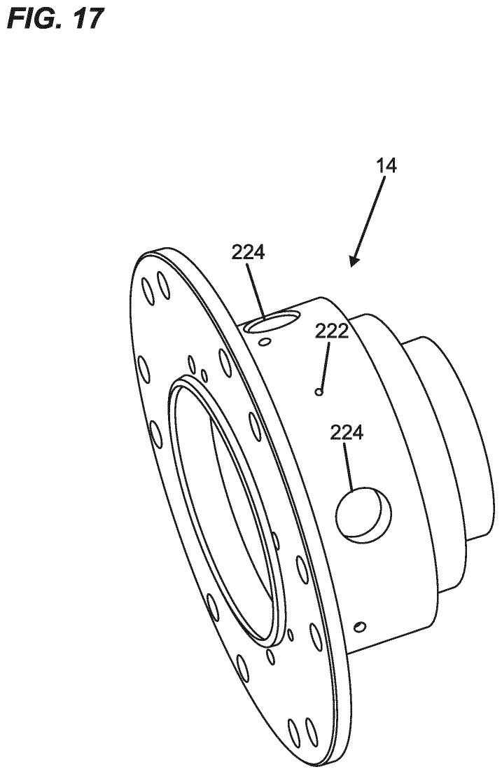

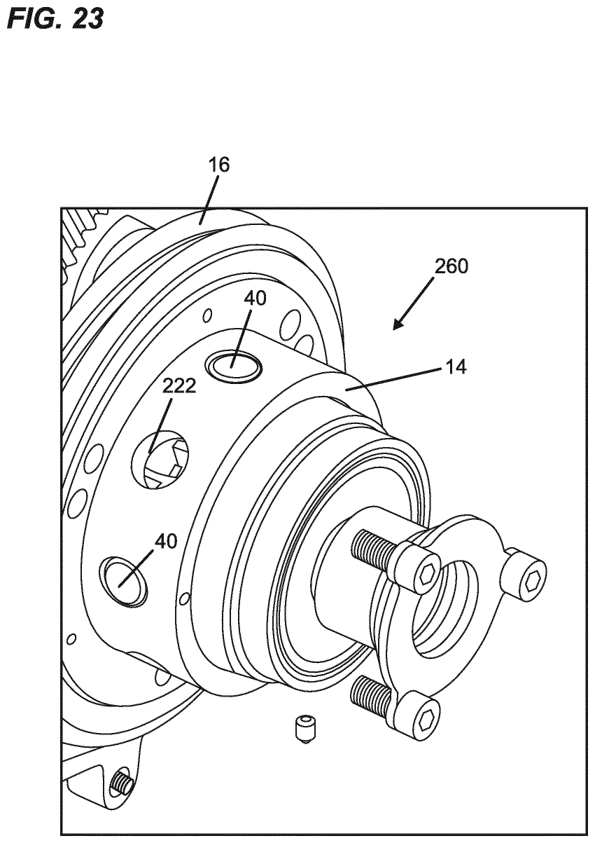

In certain implementations, some of the lubrication fluid flowing along the inlet pathway 202 enters the differential case 14 instead of being routed to the planetary gear arrangement 50. For example, the lubrication fluid may flow along one or more apertures 222 defined in the differential case 14 (e.g., see FIG. 14). In some implementations, lubrication enters aperture 222 due to high pressure in region 45 of the housing due to lubrication pressure retained because of seals 49 placed in the housing chamber 45 (e.g., see FIG. 11). In such implementations, the aperture 222 is smaller than apertures 224 through which the pinion shafts 40 are accessible (e.g., see FIG. 17). In other implementations, the lubrication enters the interior cavity 47 of the differential case 14 through a larger aperture 222 due to rotation of the differential case 14 (e.g., see FIG. 23).

Upon entering the differential case 14, lubrication can splash around within the chamber 47, for example, reaching a thrust washer interface 57 between the side gears 38 and the differential case 14. In another example, the splashing lubrication flows through apertures 210 defined in the differential case 14 to reach a bearing arrangement 59 (e.g., a needle bearing arrangement) for one or more of the axles 30 (e.g., see FIG. 12). In certain implementations, the differential case 14 defines one or more apertures 208 that lead from the interior cavity 47 towards a bearing arrangement 55 (e.g., a ball bearing arrangement) between the differential case 14 and the assembly cover 12b. In some implementations, the splashing fluid within the cavity 47 flows through the apertures 208 to the bearing arrangement 55.

In certain implementations, one or more components of the differential gear arrangement 15 define pathways allowing lubrication to be directed towards targeted areas of the differential gear arrangement 15 (e.g., see FIGS. 10-12). In certain implementations, one or more of the pinion shafts 40 of the differential case 14 defines a shaft pathway 204 through the pinion shaft 40 leading towards a center of the differential gear arrangement 15 to outlet pathways 206. The shaft pathways 204 are accessible through apertures 224 (e.g., see FIG. 17) defined in the differential case 14 in alignment with the pinion shafts 40. In certain examples, the outlet pathways 206 are angled relative to the shaft pathway 204. In certain examples, the outlet pathways 206 direct the lubrication towards the interface between the pinion gears 48 and the side gears 38.

In certain examples, directing the lubrication along the shaft pathway 204 creates a jet of fluid that is then directed along the outlet pathways 206 to spray out onto a targeted region of the differential gear set 15. For example, the lubrication is first directed towards a central location within the differential case 14 along the shaft paths 204. In certain examples, the lubrication enters the rotating shaft pathway 204 due to high pressure created by the seals 49 between the housing 12 and the differential case 14 e.g., see FIG. 11). At or near the central location, the lubrication is then turned at least 90 degrees relative to the shaft path 204 and directed along one or more outlet paths 206. In certain examples, the lubrication is turned between 120 degrees and 160 degrees between the shaft path 204 and the outlet path 206. In certain examples, the lubrication is turned about 135 degrees between the shaft path 204 and the outlet path 206.

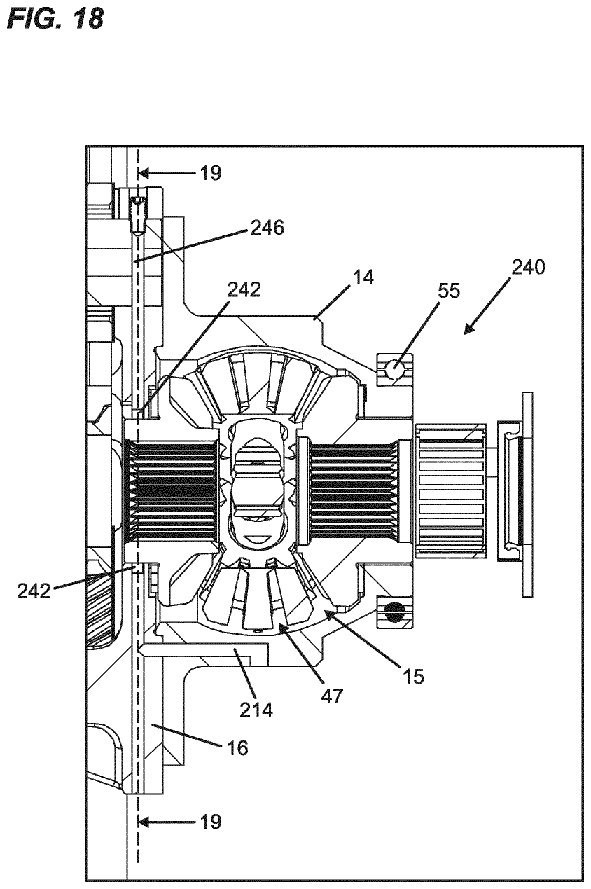

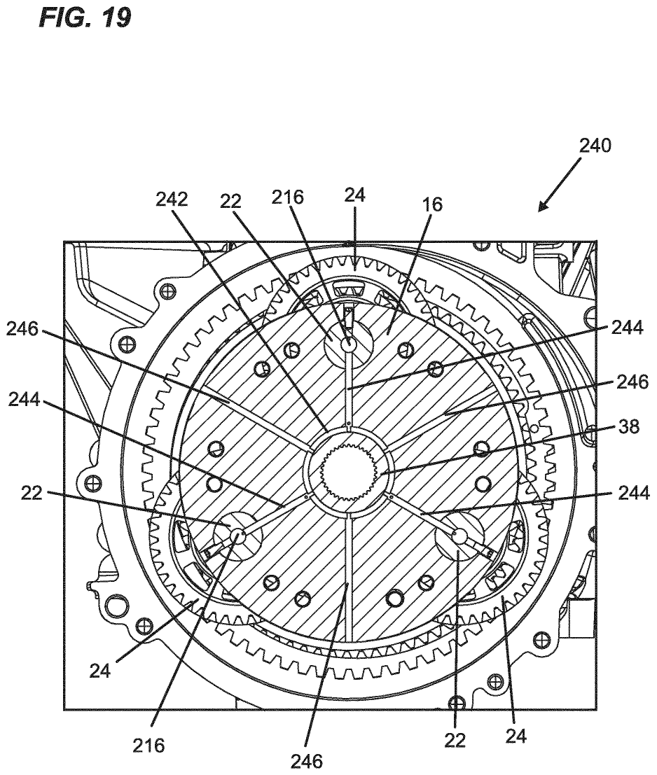

In certain implementations, this concept of directing lubrication fluid first centrally and then outwardly to targeted areas also can be applied to the planetary gear arrangement 150 (e.g., see FIGS. 18-20) in a centrifugal assist lubrication system. In certain implementations, the carrier 16 defines a well 242 at a location at or near the rotation axis X of the differential case 14 (e.g., see FIGS. 18 and 19). In certain examples, the well 242 forms a ring around one of the side gears 38 (e.g., see FIG. 19). First radial paths 246 lead radially inwardly from the bridging path 214 to the well 242. Second radial paths 243 lead radially outwardly from the well 242 to the pin paths 216 at the planet gears 24. The well 242 is disposed near a center of rotation of the differential 10. Accordingly, directing the lubricant radially inwardly and then radially outwardly along the radial paths 246, 244 increases the pressure of the lubricant by taking advantage of the centrifugal force acting on the lubricant within the well 242. In certain implementations, respective paths 250 lead from the well 242 to the interface between the sun gear 32 and the first portion 24a of each planet gear 24.

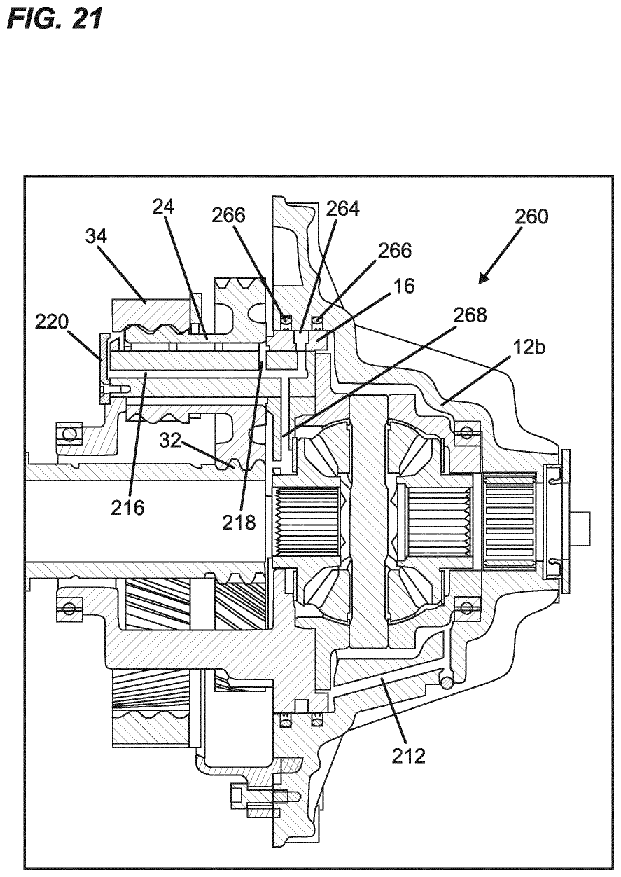

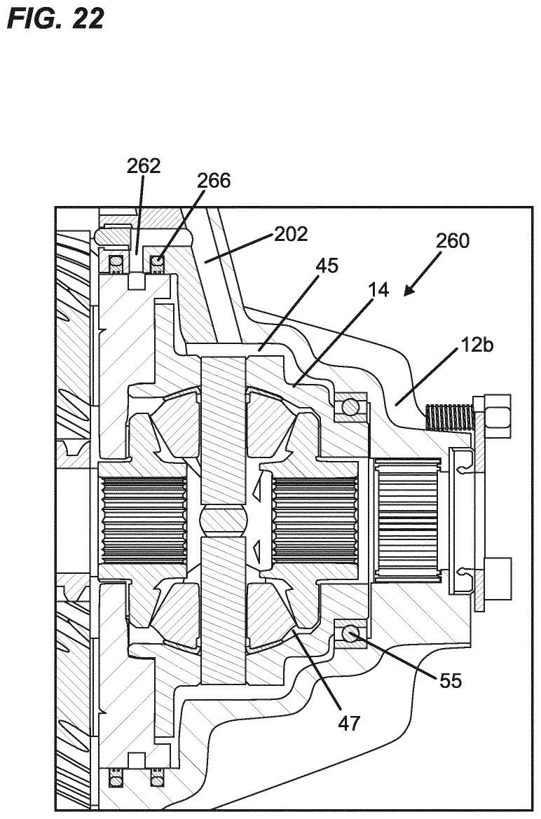

In some implementations, the lubrication system directs the lubricant from the housing 12, through the differential case 14, to the carrier 16 to reach the planetary gear arrangement 50 (e.g., see FIGS. 10-20). In other implementations, however, the lubrication system 260 directs the lubrication from the housing 12 directly to pathways defined in the carrier 16 to reach the planetary gear system 50 (e.g., see FIGS. 21-23). For example, a pathway 262 may stem from the inlet pathway 202 upstream of the interior chamber 45 of the housing 12 (e.g., see FIG. 22). The pathway 262 leads to an aperture 264 through the carrier 216 leading to the pin pathways 216 of the planet gears 24 (e.g., see FIG. 21). The aperture 264 through the carrier 216 is sealed from the differential case 14 by seals (e.g., o-rings, gaskets, grommets, etc.) 266. In certain implementations, pathways 268 through the carrier 16 also lead to the interface between the sun gear 32 and the first portion 24a of each planet gear 24.

As noted above, the various types of lubrications systems for the planetary gear set 50 can be mixed with the various types of lubrication systems for the differential gear set 15. FIGS. 10-12 illustrate a first example lubrication system 200 including a forced lubrication system for the differential case 14 supplemented by shaft pathways 204 enabling forced lubrication to the differential gear set. The first lubrication system 200 also includes a first type of forced lubrication system for the planetary gear set 50 in which the bridging path 214 leads through the differential case 14.

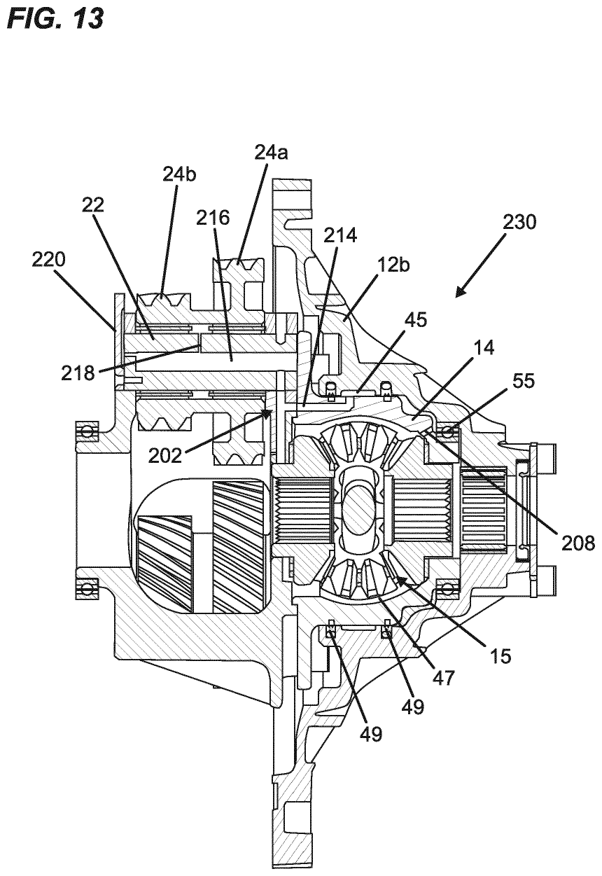

FIGS. 13-17 illustrate a second example lubrication system 230 that utilizes the same forced lubrication system for the planetary gear set 50 as the first lubrication system 200. The second lubrication system 230, however, does not include shaft pathways 204. Rather, the second lubrication system 230 directs lubrication to the interior chamber 47 of the rotating differential case 14 within which the lubrication can continuously splash around during rotation of the differential 10.

FIGS. 18-20 illustrate a third example lubrication system 240 in which the bridging path 214 from the differential case 14 leads to a centrifugal path 246, 242, 244 at the carrier 16 to assist in directing lubricant to the planetary gear set 50. In certain implementations, the third lubrication system 240 has the same differential case lubrication system as the second lubrication system 230. In certain implementations, the bridging path 214 of the first, second, and third lubrications systems 200, 230, 240 extends through both the differential 14 and the carrier 16. For example, the lubrication flows from the housing 12 into the internal chamber 45, through the differential case 14, to the carrier 16 to reach the planetary gear arrangement 50.

FIGS. 21-23 illustrate a fourth example lubrication system 260 where the lubrication directed to the planetary gear set 50 is split from the lubrication directed to the differential case 14 upstream of the differential case 14. In such implementations, a continuous flow of lubrication is directed from the housing 12, to the carrier 16, and to the planetary gear set 50. In some such implementations, another continuous flow of lubrication is directed from the housing 12 to the differential case 14. In other such implementations, a predetermined amount of lubrication is trapped within the chamber 45 between the differential case 14 and the housing 12.

For the purposes of this application, directional terms (e.g. “left”, “right”, “upper,” “lower,” “upward,” and “downward”, etc.) are intended to be descriptive with reference to and in relation to the orientation shown in the figures for clarity, but the examples as practiced and included in the scope of the claims may include examples where the systems and devices are in a different orientation.

While particular uses of the technology have been illustrated and discussed above, the disclosed technology can be used with a variety of environments in accordance with many examples of the technology. The above discussion is not meant to suggest that the disclosed technology is only suitable for implementation within the environments shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects described with respect to the figures herein are not intended to limit the technology to the particular aspects described. Accordingly, additional configurations can be used to practice the technology herein and/or some aspects described can be excluded without departing from the methods and systems disclosed herein.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein.

1. A reduction drive unit comprising:
a) a differential arrangement including a differential case that houses-housing a plurality of pinion gears intermeshed with a pair of side gears; and
b) a compound planetary gear arrangement including a sun gear, a ring gear, and a plurality of planet gears, wherein each of the plurality of planet gears has a first stage gear intermeshed with the sun gear and an axially offset second stage gear intermeshed with the ring gear, the ring gear being fixed relative to the differential case.

2. The reduction drive unit of claim 1, wherein the ring gear is axially offset from the sun gear such that the sun gear is located axially between the ring gear and the differential arrangement, and wherein the sun gear is positioned outside of a radial envelope defined by the differential case.

3. The reduction drive unit of claim 1, wherein the differential case acts as a carrier for the plurality of planet gears.

4. The reduction drive unit of claim 1, wherein the compound planetary gear arrangement includes a carrier structure rotationally supporting the plurality of planet gears, the carrier structure being rigidly mounted to the differential case.

5. The reduction drive unit of claim 1, wherein the plurality of planet gears includes three planet gears.

6. The reduction drive unit of claim 5, wherein the plurality of pinion gears includes three pinion gears.

7. The reduction drive unit of claim 5, wherein the plurality of pinion gears includes four pinion gears.

8. The reduction drive unit of claim 1, further comprising a hollow drive shaft for connection with an electric motor, the hollow drive shaft extending over and being coaxially aligned with one of a pair of half-shafts, each half-shaft being coupled to one of the side gears.

9. The reduction drive unit of claim 8, wherein the sun gear is formed with the hollow drive shaft.

10. The reduction drive unit of claim 8, wherein the sun gear is coupled to the hollow drive shaft.

11. The reduction drive unit of claim 1, further comprising a gear reduction housing, which includes a first housing part coupled to a second housing part, wherein the differential arrangement is housed entirely within the first housing part, and wherein the sun gear, the ring gear, and the plurality of planet gears are housed entirely within the second housing part.

12. The reduction drive unit of claim 1, further comprising a lubrication forced circulation pathway along which lubrication is pumped to the compound planetary gear arrangement during operation of the reduction drive unit.

13. The reduction drive unit of claim 12, wherein the lubrication forced circulation pathway also extends through the differential arrangement.

14. The reduction drive unit of claim 13, wherein the lubrication forced circulation pathway includes bores defined in the differential case to enable lubrication to splash within the interior of the differential case.

15. The reduction drive unit of claim 14, wherein the lubrication forced circulation pathway includes bores through pinions of the pinion gears that lead from the differential case interior to a center of the differential arrangement.

16. The reduction drive unit of claim 12, wherein the lubrication forced circulation pathway bypasses the differential arrangement as the lubrication forced circulation pathway extends to the planetary gear arrangement.

17. The reduction drive unit of claim 12, wherein the lubrication forced circulation pathway includes bores through pins of the planet gears of the compound planetary gear arrangement.

18. The reduction drive unit of claim 12, wherein the lubrication forced circulation pathway includes a centrifugal assist lubrication system in which lubrication is directed to a central well defined by a carrier and then towards the planet gears.

19. A reduction drive unit comprising:
a) a differential arrangement including a differential case housing a plurality of pinion gears intermeshed with a pair of side gears; and
b) a compound planetary gear arrangement including a sun gear, a fixed ring gear, a plurality of planet gears, and a carrier structure rotationally supporting the plurality of planet gears, wherein:
i) the carrier structure is rigidly mounted to the differential case;
ii) each of the plurality of planet gears has a first stage gear intermeshed with the sun gear and an axially offset second stage gear intermeshed with the fixed ring gear; and
iii) the ring gear is axially offset from the sun gear such that the sun gear is located axially between the ring gear and the differential arrangement.

20. A reduction drive unit comprising:
a) a housing assembly including a first housing part mated to a second housing part;
b) a differential arrangement including a differential case housing a plurality of pinion gears intermeshed with a pair of side gears, the differential arrangement being housed entirely within the first housing part; and
c) a compound planetary gear arrangement including a sun gear, a fixed ring gear, a plurality of planet gears, and a carrier structure rotationally supporting the plurality of planet gears, wherein:
i) the carrier structure is rigidly mounted to the differential case;
ii) each of the plurality of planet gears has a first stage gear intermeshed with the sun gear and a second stage gear intermeshed with the fixed ring gear; and
iii) the sun gear, the fixed ring gear, and the plurality of planet gears are housed entirely within the second housing part.
